(19) United States
(12) Patent Application Publication
(10) Pub. No.: US 2024/0336320 A1
(43) Pub. Date: Oct. 10, 2024

(54) CHAINRING AND TOOL FOR ELECTRIC BICYCLE

(71) Applicant: Alex TRIMNELL, Poole, Dorset (GB)

(72) Inventor: Alex TRIMNELL, Poole, Dorset (GB)

(21) Appl. No.: 18/290,648

(22) PCT Filed: Aug. 22, 2022
(86) PCT No.: PCT/GB2022/052165

§ 371 Date: Jan. 19, 2024

(30) Foreign Application Priority Data
Aug. 27, 2021 (GB) 2112316.1

(51) Int. Cl. B62J 50/16; B25B 27/00; B62M 9/00

(52) U.S. Cl. CPC B62J 50/16; B25B 27/0071; B62M 9/00

(57) ABSTRACT

This invention relates to a tool for insertion into an aperture on a chainring of an electric bicycle, the tool comprising a body which is shaped to abut a pedal arm of the electric bicycle and a head which is shaped to be received by the aperture. This invention also relates to a chainring for an electric bicycle comprising an aperture which is shaped to receive a complementarily shaped tool. In addition, this invention relates to a kit comprising the chainring and the tool, as well as to a method of cleaning and/or lubricating a drivetrain of an electric bicycle using the tool and the chainring.

This invention relates to chainring for an electric bicycle, the chainring comprising an aperture which is shaped to receive a complementarily shaped tool. This invention also relates to a tool for insertion into an aperture on a chainring of an electric bicycle, the tool comprising a body which is shaped to abut a pedal arm of the electric bicycle and a head which is shaped to be received by the aperture.

### BACKGROUND

The drivetrain of a bicycle generally comprises the mechanical parts that are involved in producing the movement of the bicycle. The drivetrain components for a bicycle include the pulley wheel, one or more chainrings, the chain and the cassette.

To clean and/or lubricate one or more of the drivetrain components of a bicycle it is best to turn the pedals backwards and work in one area as the chain rotates through. By rotating the pedals backwards, this can be done without the wheels moving.

Standard chainrings on an electric bicycle (e-bike) do not rotate backwards with the pedal arm which makes the cleaning and lubrication process difficult. Using a non-standard tool to try and provide this function risks damaging the bicycle. An improved way of cleaning and/or lubricating the drivetrain components of an electric bicycle has been sought.

### STATEMENT OF INVENTION

This invention relates to a chainring for an electric bicycle comprising an aperture which is shaped to receive a complementarily shaped tool.

In particular, the aperture may be shaped such that the tool cannot rotate once it has been received in the aperture. More particularly, the aperture may be shaped as a cross or plus sign. In other embodiments, the aperture may be shaped such that the tool can rotate once it has been received in the aperture.

In particular, the aperture may have a chamfered edge. This can assist the user in locating the tool into the aperture.

More particularly, the chainring may be substantially circular or substantially elliptical, even more particularly substantially circular.

This invention also relates to a tool for insertion into an aperture on a chainring of an electric bicycle, the tool comprising a body which is shaped to abut a pedal arm of the electric bicycle and a head which is shaped to be received by the aperture.

In particular, the body may comprise a first end from which the head extends, and a second end. More particularly, the second end may be provided with a connector for attaching the tool to a keychain or similar. In particular, the tool may comprise a chamfer between the head and the first end of the body. More particularly, the chamfer may be shaped to mate with a corresponding chamfered edge of the aperture.

In particular, the head may have a cross-section such that the tool is substantially prevented from rotating once it has been received in the aperture. More particularly, the head may have a cross-section which is shaped as a cross or plus sign. In other embodiments, the head may have a cross-section such that the tool can rotate once it has been received in the aperture.

In particular, the head may comprise one or more of either a spring plunger or an indexing plunger for assisting in locating and releasably retaining the head in the aperture. More particularly, the one or more spring plunger or indexing plunger may be positioned such that it is depressed as the head is pushed into the aperture, and is then released as the head reaches a final position in the aperture. In particular, the one or more spring plunger or indexing plunger may then abut an opposite face of the chainring from that which they are pushed into, thereby assisting to retain the tool in the aperture. The one or more spring plunger or indexing plunger helps to hold the tool in place, thereby minimising sideways movement. This allows the tool to have a tighter fit within the aperture whilst minimising the risk of tool binding or being jammed into the pedal arm.

More particularly, the head may comprise two spring plungers for assisting in locating and releasably retaining the head in the aperture. In particular, the head may comprise two opposing faces and a spring plunger may be provided on each opposing face. In some embodiments, the head may comprise four spring plungers for assisting in locating and releasably retaining the head in the aperture. In particular, the head may comprise two pairs of opposing faces and a spring plunger may be provided on each opposing face. These spring plungers assist in allowing the tool to be retained in the aperture during use, but then to be easily released once the tool is no longer required.

More particularly, the body may have a larger diameter than the head.

In particular, the body may have a resilient material provided on its surface. More particularly, the resilient material may be rubber or a silicone. In particular, the resilient material may be provided either in the form of a coating on the body or as a separate component (e.g. a cover or sleeve) which can be fitted over the body.

In addition, this invention relates to a kit comprising:
(a) a chainring as described above, and
(b) a tool as described above.

Furthermore, this invention relates to a method cleaning and/or lubricating a drivetrain of an electric bicycle, the method comprising the steps of:
(a) inserting a tool as described above into the aperture of a chainring as described above,
(b) rotating a pedal arm of the electric bicycle backwards until the pedal arm abuts the tool,
(c) rotating the pedal arm further in a backwards direction such that the chainring rotates with the pedal arm, and
(d) cleaning and/or lubricating the drivetrain.

In the context of the invention, the term “outer” is used to mean further from a central axis of the chainring (i.e. around which the chainring rotates during use) and “inner” is used to mean closer to the central axis of the chainring.

### BRIEF DESCRIPTION OF THE DRAWINGS

This invention will be further described by reference to the following Figures which are not intended to limit the scope of the invention claimed, in which:

FIG. 1 shows a perspective view of a chainring and a tool according to the invention, prior to the insertion of the tool into the aperture in the chainring,

FIG. 2 shows a side-on view of the chainring and tool of FIG. 1 prior to the insertion of the tool into the aperture on the chainring

FIG. 3 shows a perspective view of the chainring and tool of FIG. 1 after the insertion of the tool into the aperture on the chainring,

FIG. 4 shows a plan view of the chainring and tool of FIG. 1 after the insertion of the tool into the aperture on the chainring,

FIG. 5 shows a close-up perspective view of the chainring and tool of FIG. 1 after the insertion of the tool into the aperture on the chainring, and from the opposite side of the chainring to that shown in FIG. 3,

FIG. 6 shows a close up perspective view of a first end of the tool of FIG. 1,

FIG. 7 shows a side-on view of the tool of FIG. 1,

FIG. 8 shows a close-up view of the circled area labelled “A” in FIG. 7,

FIG. 9 shows a cross-sectional view of a ball spring plunger as used in the tool of FIG. 1, and

FIGS. 10 (a)-(c) show three stages in the method of using the chainring and tool of FIG. 1 in order to clean and/or lubricate one of more drivetrain components of an electric bicycle.

### DETAILED DESCRIPTION

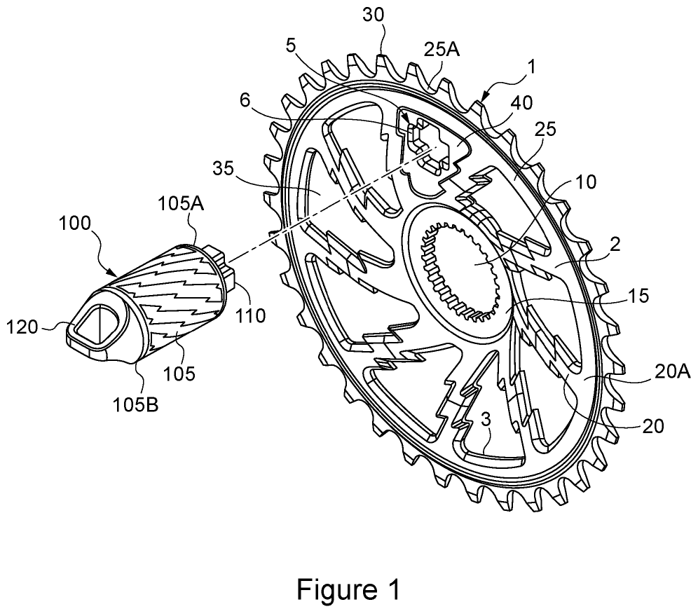

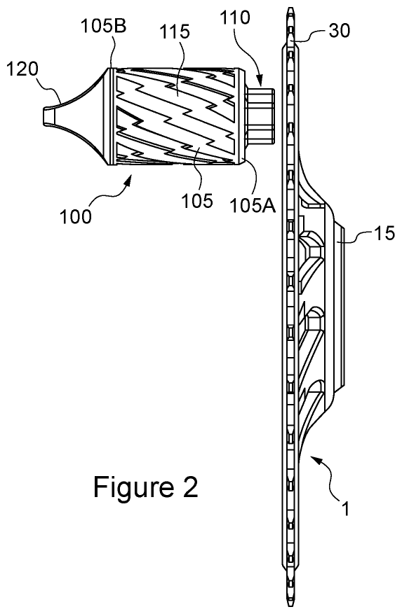

FIGS. 1 and 2 show perspective and side-on views respectively of a chainring 1 and a tool 100 according to one embodiment of the invention. The chainring 1 comprises tool aperture 5 (described in more detail below), and the tool 100 is shown prior to insertion into the aperture 5. For ease of reference, not all of the component parts described below are labelled in FIG. 2.

Chainring 1 is circular in shape and comprises two opposing faces 2, 3. Although not shown in the figures, elliptical or oval chainrings can also be utilised within the scope of the invention. Chainring 1 also comprises central through hole 10 for accepting an axle to which pedal arms are attached (not shown in FIGS. 1-4).

Extending radially from a hub 15 around central through hole 10 are spider arms, one of which is indicated 20 by way of example. In the embodiment shown in the Figures, there are nine spider arms 20, which are formed with a lightning bolt shape. However, different numbers of spider arms, and with different shapes, can also be utilised within the scope of the invention.

Outer end 20A of spiders arms 20 connect to external ring 25. External ring 25 is provided at its outer edge 25A with teeth, one of which is indicated 30 by way of example. The teeth 30 are shaped to engage a chain (not shown in FIGS. 1-4) of an electric bicycle.

The spider arms 20 which extend radially from hub 15 to external ring 25 form spider apertures, one of which is indicated 35 by way of example, between each spider arm 20. In the embodiment shown in the Figures this results in the formation of nine such spider apertures.

One of the spider apertures 40 of the chainring 1 is different from the others in that it is partially filled in such that the resulting aperture 5 is shaped to receive tool 100. In the embodiment shown in the Figures, tool aperture 5 is shaped as a plus sign or cross. However, other tool aperture shapes can be utilised in the invention provided that they are shaped to receive a corresponding part of tool 100. In some embodiments, it can be advantageous for the tool aperture 5 and the tool 100 to be shaped such that the tool 100 is substantially prevented from rotating when received by the tool aperture 5.

Tool aperture 5 is provided around its edge on both faces 2, 3 with chamfer 6. The chamfer 6 can assist the user in locating the tool 100 into the tool aperture 5.

As shown in FIGS. 1-6, tool 100 comprises tool body 105 which at a first end 105A is provided with tool head 110 extending from tool body 105. In the embodiment shown in the Figures, tool head 110 is shaped as a plus sign such that it can be accepted by tool aperture 5 of chainring 1. In this way. tool head 110 is prevented from rotating when it is received by tool aperture 5.

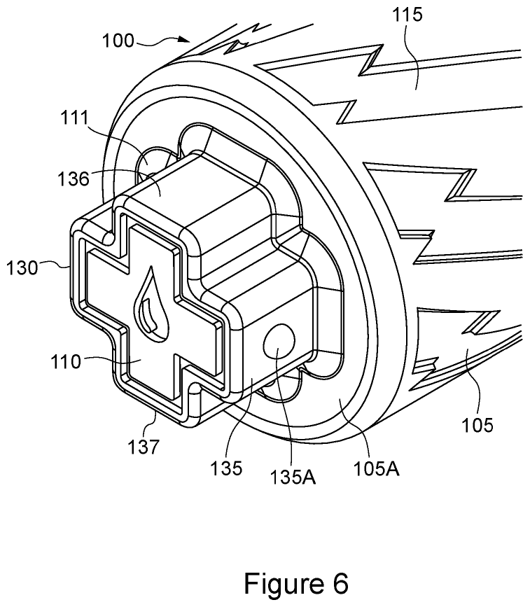

As shown particularly in FIG. 6, a chamfer 111 is provided at a first end 105A of tool 100 where tool head 110 meets tool body 105. This chamfer 111 has a shape which corresponds to chamfer 6 on chainring 1 in order to provide a good fit between the tool 100 and the chainring 1.

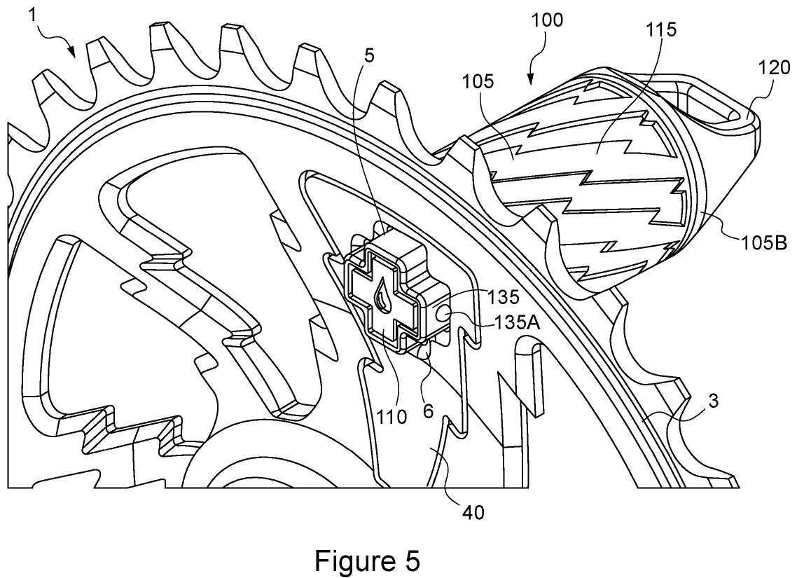

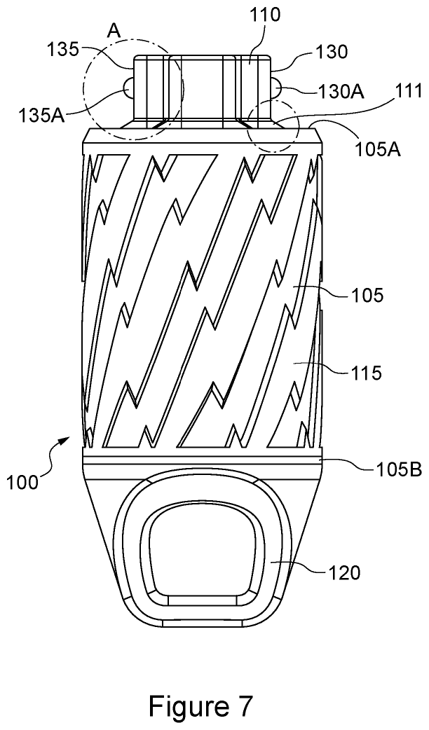

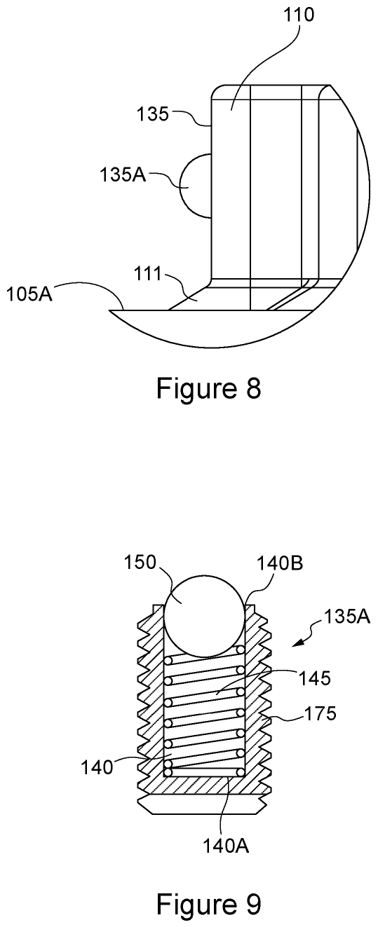

As shown particularly in FIGS. 5-8, tool head 110 is provided on two opposing side faces 130, 135 with ball spring plungers 130A, 135A. Although not shown in the embodiment in the Figures, in other embodiments two further ball spring plungers could be provided on opposing side faces 136, 137 (see FIG. 6) of tool head 110. The structure of such ball spring plunger 135A is shown in FIG. 9 (ball spring plunger 130A is identical). Each ball spring plunger comprises a cylindrical housing 175 in which is formed a cylindrical recess 140. The cylindrical recess 140 comprises one closed end 140A and one open end 140B. A spring 145 is provided which extends from the closed end 140A. The end of the spring 145 closest to the open end 140B is in contact with ball bearing 150. The diameters of the open end 140B and the ball bearing 150 are such that the ball bearing is retained in the cylindrical recess 140, but that it can be pushed into the cylindrical recess 140 when force is applied such that the spring is compressed. The ball bearing 150 is then returned to its original position by expansion of the spring 145 once the force is removed. Thus, when the tool head 110 is pushed into tool aperture 5, the ball bearings in ball spring plungers 130A, 135A are pushed into tool head 110. As shown in FIG. 5, once the tool head 110 has been fully pushed through tool aperture 5 the ball bearings in ball spring plungers 130A, 135A returned to their original position, thereby helping to retain the tool 100 in tool aperture 5.

Tool body 105 is cylindrical. However, other tool body shapes can be utilised in the invention. The external surface of tool body 105 is provided with silicone coating 115 which substantially prevents the tool 100 from scratching other components of the bicycle, e.g. the pedal arm.

At its opposite, second end 105B, extending from tool body 105 is loop 120. Loop 120 is provided so that the tool 100 can be attached to a keychain or similar.

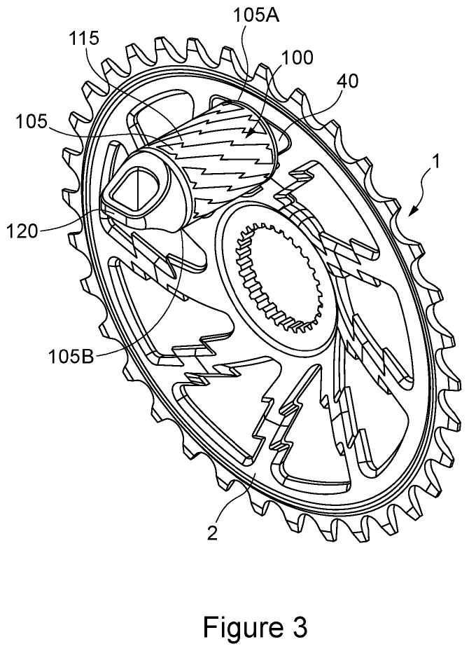

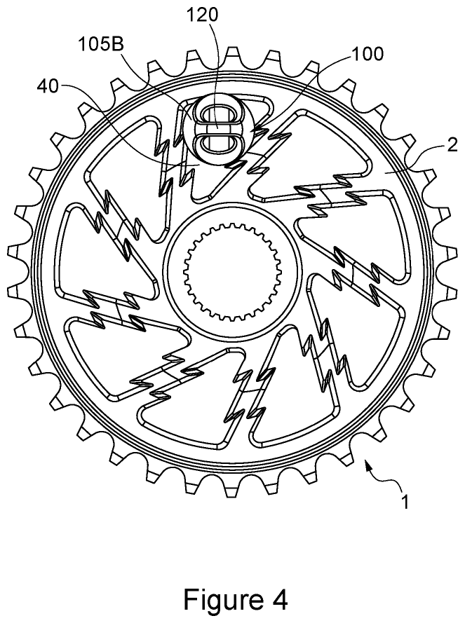

FIGS. 3 and 4 show perspective and side-on views respectively of the tool 100 when inserted into aperture 5 of chainring 1. Tool head 110 is within aperture 5 (not visible in FIGS. 3 and 4) such that the first end 105A of tool body 105 abuts face 2 of chainring 1. For ease of reference, not all of the component parts described above are labelled in FIGS. 3 and 4.

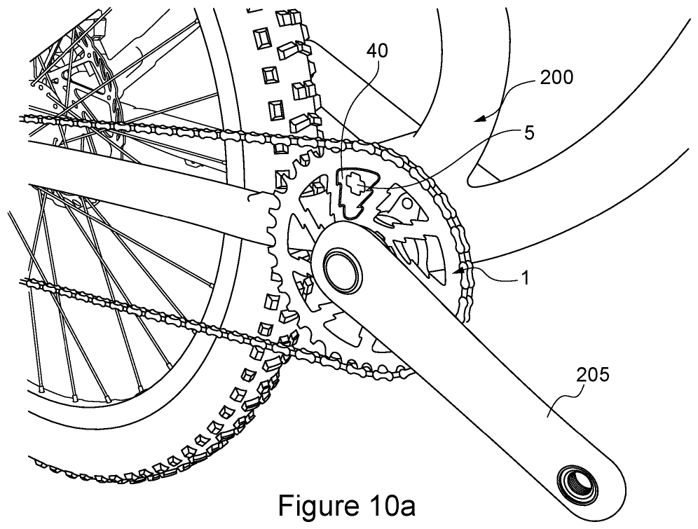

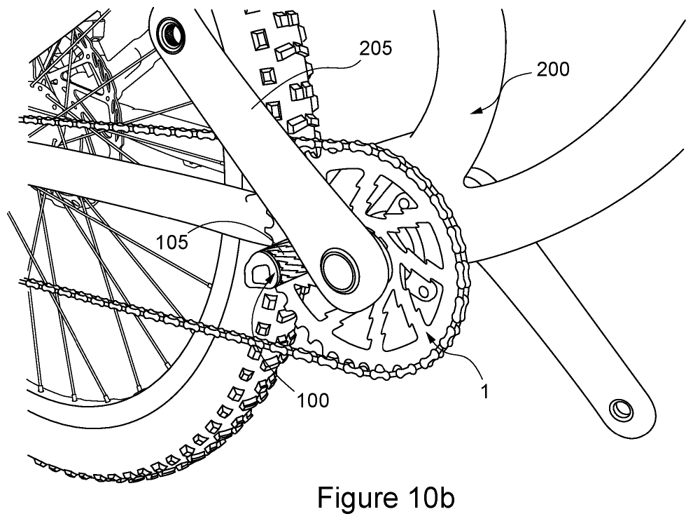

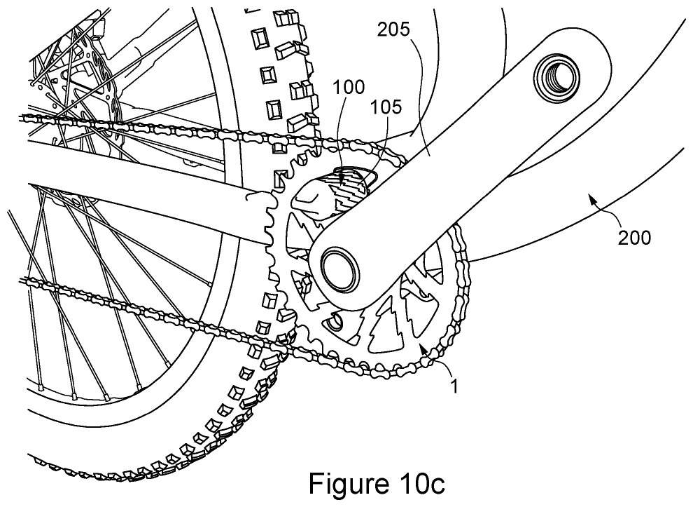

FIGS. 10 (a)-(c) show the chainring 1 and the tool 100 of the invention in use with an electric bicycle. FIG. 10 (a) shows an electric bicycle, indicated generally as 200, with chainring 1 fitted. Pedal arm 205 of electric bicycle 200 is in a position such that tool aperture 5 is visible.

In FIG. 10 (b), tool 100 has been inserted into tool aperture 5 of chainring 1. In addition, the pedal arm 205 of electric bicycle 200 has been rotated in a backwards direction such that it then abuts tool body 105 of tool 100.

The user can then continue to rotate the pedal arm 205 as shown in FIG. 10 (c). The pedal arm 205 pushes against the tool body 105 of tool 100, which results in the chainring 1 rotating backwards with the pedal arm 205. The user can then proceed with cleaning and or lubricating one or more drivetrain components of the electric bicycle 200.

1. A tool for insertion into an aperture on a chainring of an electric bicycle, the tool comprising a body which is shaped to abut a pedal arm of the electric bicycle and a head which is shaped to be received by the aperture.

2. A tool as claimed in claim 1, wherein the head has a cross-section such that the tool is substantially prevented from rotating once it has been received in the aperture.

3. A tool as claimed in claim 2, wherein the head has a cross-section which is shaped as a cross or plus sign.

4. A tool as claimed in claim 1, wherein in the head comprises one or more of either a spring plunger or an indexing plunger for assisting in locating and releasably retaining the head in the aperture.

5. A tool as claimed in claim 4, wherein in the head comprises two spring plungers for assisting in locating and releasably retaining the head in the aperture.

6. A tool as claimed in claim 1, wherein the body has a larger diameter than head.

7. A tool as claimed in claim 1, wherein the body comprises a first end from which the head extends, and a second end, and the tool comprises a chamfer between the head and the first end of the body.

8. A tool as claimed in claim 1, wherein the body has a resilient material provided on its surface.

9. A tool as claimed in claim 8, wherein the resilient material is a rubber or a silicone.

10. A chainring for an electric bicycle comprising an aperture which is shaped to receive a complementarily shaped tool.

11. A chainring as claimed in claim 10, wherein the aperture is shaped such that the tool cannot rotate once it has been received in the aperture.

12. A chainring as claimed in claim 11, wherein the aperture is shaped as a cross or plus sign.

13. A chainring as claimed in claim 10, wherein the aperture has a chamfered edge.

14. A kit comprising
(a) a chainring comprising an aperture which is shaped to receive a complementarily shaped tool, and
(b) the complementarily shaped tool comprising a body which is shaped to abut a pedal arm of the electric bicycle and a head which is shaped to be received by the aperture.

15. A method of cleaning and/or lubricating a drivetrain of an electric bicycle, the method comprising the steps of:
(a) inserting a tool comprising a body which is shaped to abut a pedal arm of the electric bicycle and a head which is shaped to be received by the aperture into the aperture of a chainring comprising an aperture which is shaped to receive the tool,
(b) rotating the pedal arm of the electric bicycle backwards until the pedal arm abuts the tool,
(c) rotating the pedal arm further in a backwards direction such that the chainring rotates with the pedal arm, and
(d) cleaning and/or lubricating the drivetrain.
